(19) United States
(12) Patent Application Publication
(10) Pub. No.: US 2006/0031853 A1
(43) Pub. Date: Feb. 9, 2006

(54) System and method for optimizing processing speed to run multiple dialogs between multiple users and a virtual agent

(75) Inventor: Michael Kuperstein, Wellesley, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Metaphor Solutions, Inc., Wellesley, MA (US)

(21) Appl. No.: 11/145,540

(22) Filed: Jun. 3, 2005

Related U.S. Application Data
(63) Continuation-in-part of application No. PCT/US04/33186, filed on Oct. 8, 2004.
Application No. PCT/US04/33186 is a continuation-in-part of application No. 10/915,955, filed on Aug. 11, 2004.
(60) Provisional application No. 60/510,699, filed on Oct. 10, 2003.
(60) Provisional application No. 60/578,031, filed on Jun. 8, 2004.

(51) Int. Cl. G06F 9/44

(52) U.S. Cl. 719/320

(57) ABSTRACT

A speech dialog management system where each dialog is capable of supporting one or more turns of conversation between a user and virtual agent using any one or combination of a communications interface and data interface. The system includes compiled application libraries, which determine the recognition, response, and flow control in a dialog with a user. A process of execution of a compiled application library runs throughout the conversation, putting itself into a dormant state in between processing of the communications from the user. A script manager brokers information between the processes of execution of the compiled application libraries and many communications with users.

### RELATED APPLICATIONS

This application is a continuation-in-part of International Application No. PCT/US2004/033186, which designated the United States and was filed on Oct. 8, 2004, published in English, which is a continuation-in-part of U.S. application Ser. No. 10/915,955, filed on Aug. 11, 2004, which claims the benefit of U.S. Provisional Application No. 60/510,699, filed on Oct. 10, 2003. This application also claims the benefit of U.S. Provisional Application No. 60/578,031, filed on Jun. 8, 2004. The entire teachings of the above referenced applications are incorporated herein by reference.

### BACKGROUND OF THE INVENTION

Initially, touch tone interactive voice response (IVR) had a major impact on the way business was done at call centers. It has significantly reduced call center costs and is automatically completing service calls at an average rate of about 50%. However, the caller experience of wading through multiple levels of menus and frustration of not getting to where the caller wants to go, has made this type of service the least favorite among consumers. Also, using the phone keypad is only useful for limited types of caller inputs.

After many years in development, a newer type of automation using speech recognition is finally ready for prime time at call centers. The business case for implementing automated speech response (ASR) has already been proved for call centers at such companies as United Airlines, FedEx, Thrifty Car Rental, Amtrak and Sprint PCS. These and many other companies are saving 30-50% of their total call center costs every year as compared to using all live service agents. The return on investment (ROI) for these cases is in the range of about 6-12 months, and the companies that are upgrading from touch tone IVR to ASR are getting an average rate of call completion of about 80% and savings of an additional 20-50% of the total costs over IVR.

Not only do these economics justify call centers to start adopting automated speech response, but there are other major benefits to using ASR that increase the quality of the service to consumers. These include zero hold times, reduction of frustrated callers, a homogeneous pleasant presentation to callers, quick accommodation to spikes in call volume, shorter call durations, much wider range of caller inputs over IVR, identity verification using voice and the ability to provide callers with additional optional purchases. In general ASR allows callers to get what they want easier and faster than touch tone IVR.

However, when technology buyers at call centers understand all the benefits and ROI of ASR and then try to implement an ASR solution themselves, they are often faced with sticker shock at the cost of developing and deploying a solution.

The large costs are in developing and deploying the actual software that automates the service script itself. Depending on the complexity of the script, dialog and back-end integration, costs can run anywhere from $200,000 to $2,500,000. At these prices, the only economic justification for deploying ASR solutions and getting a ROI in less than a year is for call centers that use from several hundred to several thousand live agents for each application. Examples of these applications include phone directory services and TV shopping network stations.

But what about the vast majority of the 80,000 call centers in the U.S. that are mid-sized and use 50-200 live agents per application? At these integration costs, the economic justification, for mid-sized call centers, falls apart and as a result they are not adopting ASR.

A large part of the integration costs are in developing customized ASR dialogs. The current industry standard interface languages for developing dialogs are Voice XML and SALT. Developing dialogs in these languages is very complex and lengthy, causing development to be very expensive. The reason they are complex include:
VoiceXML and SALT are based on XML syntax with a strong constraint on formal syntax that is easy for a computer to read but taxing on a person to manually develop in.
Voice XML is a declarative language and not a procedural one. However, speech dialog flows are procedural.
Voice XML and SALT were designed to mimic the “forms” object in the graphical user interfaces (GUI) of websites. As a result a dialog is implicitly defined as a series of forms where a prompt is like a form label and the user response is like a text input field. However, many dialogs are not easily structured as a series of forms because of conditional flows, evolving context and inferred knowledge.

There have been a number of recent patents related to speech dialog management. These include the following:

The patent entitled “Tracking initiative in collaborative dialogue interactions” (U.S. Pat. No. 5,999,904) discloses methods and apparatus for using a set of cues to track task and dialogue initiative in a collaborative dialogue. This patent requires training to improve the accuracy of an existing directed dialog management system. It does not reduce the cost of development, which is one of the major values of the present invention.

The patent entitled “Method and apparatus for executing a human-machine dialogue in the form of two-sided speech as based on a modular dialogue structure” (U.S. Pat. No. 6,035,275) discloses methods for developing a speech dialog through the use of a hierarchy of subdialogs called High Level Dialogue Definition language (HLDD) modules. This is similar to “Speech Objects” by Nuance. The patent also discloses the use of alternative subdialogs that are used if the primary subdialog does not result in a successful recognition of the person's response. This approach does reduce the development time of speech dialogs with the use of pre-tested, re-usable subdialogs, but lacks the necessary flexibility, context dependency, ease of implementation, interface to industry standard protocols and external data source integration that would result in a significant quantum reduction of the cost of development.

The patent entitled “Methods and apparatus object-oriented rule-based dialogue management” (U.S. Pat. No. 6,044,347) discloses a dialogue manager that processes a set of frames characterizing a subject of the dialogue, where each frame includes one or more properties that describe an object which may be referenced during the dialogue. A weight is assigned to each of the properties represented by the set of frames, such that the assigned weights indicate the relative importance of the corresponding properties. The dialogue manager utilizes the weights to determine which of a number of possible responses the system should generate based on a given user input received during the dialogue. The dialogue manager serves as an interface between the user and an application which is running on the system and defines the set of frames. The dialogue manager supplies user requests to the application, and processes the resulting responses received from the application. The dialogue manager uses the property weights to determine, for example, an appropriate question to ask the user in order to resolve ambiguities that may arise in execution of a user request in the application.

Although this patent discloses a flexible dialog manager that deals with ambiguities, it does not focus on fast and easy development, since it does not deal well with the following: organizing speech grammars and audio files are not efficient; manually determining the relative weights for all the frames requires much skill, creating a means of asking the caller questions to resolve ambiguities requires much effort. It does not deal well with interfaces to industry standard protocols and external data source integration.

The patent entitled “System and method for developing interactive speech applications” (U.S. Pat. No. 6,173,266) is directed to the use of re-usable dialog modules that are configured together to quickly create speech applications. The specific instance of the dialog module is determined by a set of parameters. This approach does impact the speed of development but lacks flexibility. A customer cannot easily change the parameter set of the dialog modules. Also the dialog modules work within the syntax of a standard application interface like Voice XML, which is still part of the problem of difficult development. In addition, dialog modules, by themselves do not address the difficulty of implementing complex conditional flow control inherent in good voice-user-interfaces, nor the difficulty of integration of external web services and data sources into the dialog.

The patent entitled “Natural language task-oriented dialog manager and method” (U.S. Pat. No. 6,246,981) discloses the use of a dialog manager that is controllable through a backend and a script for determining a behavior for the dialog manager. The recognizer may include a speech recognizer for recognizing speech and outputting recognized text. The recognized text is output to a natural language understanding module for interpreting natural language supplied through the input. The synthesizer may be a text to speech synthesizer. The task-oriented forms may each correspond to a different task in the application, each form including a plurality of fields for receiving data supplied by a user at the input, the fields corresponding to information applicable to the application associated with the form. The task-oriented form may be selected by scoring the forms relative to each other according to information needed to complete each form and the context of information input from a user. The dialog manager may include means for formulating questions for one of prompting a user for needed information and clarifying information supplier by the user. The dialog manager may include means for confirming information supplied by the user. The dialog manager may include means for inheriting information previously supplied in a different context for use in a present form.

This patent views a dialog as filling in a set of forms. The forms are declarative structures of the type “if the meaning of the user's text matches a specified subject then do the following”. The dialog manager in this patent allows some level of semantic flexibility, but does not address the development difficulty in real world applications for the difficulty in creating the semantic parsing that gives the flexibility, organizing speech grammars and audio files; interacting with industry standard speech interfaces, nor the difficulty of integration of external web services and data sources into the dialog.

The patent entitled “Method and apparatus for discourse management” (U.S. Pat. No. 6,356,869) discloses a method and an apparatus for performing discourse management. In particular, the patent discloses a discourse management apparatus for assisting a user to achieve a certain task. The discourse management apparatus receives information data elements from the user, such as spoken utterances or typed text, and processes them by implementing a finite state machine. The finite state machine evolves according to the context of the information provided by the user in order to reach a certain state where a signal can be output having a practical utility in achieving the task desired by the user. The context based approach allows the discourse management apparatus to keep track of the conversation state without the undue complexity of prior art discourse management systems.

Although this patent teaches about a flexible dialog manager that deals well with evolving dialog context, it does not focus on fast and easy development, since it does not deal well with the following: the difficulty in creating the semantic parsing that gives the flexibility; organizing speech grammars and audio files are not efficient; interacting with industry standard speech interfaces; and low level exception handling.

The patent entitled “Scalable low resource dialog manager” (U.S. Pat. No. 6,513,009) discloses an architecture for a spoken language dialog manager which can, with minimum resource requirements, support a conversational, task-oriented spoken dialog between one or more software applications and an application user. Further, the patent discloses that architecture as an easily portable and easily scalable architecture. The approach supports the easy addition of new capabilities and behavioral complexity to the basic dialog management services.

As such, one significant distinction from other approaches is found in the small size of the dialog management system. The dialog manager in this patent uses the decoded output of a speech grammar to search the user interface data set for a corresponding spoken language interface element and data which is returned to the dialog manager when found. The dialog manager provides the spoken language interface element associated data to the application or system for processing in accordance therewith.

This patent is a simpler form of U.S. Pat. No. 6,246,981 discussed above and is focused on use with embedded devices. It is too rigid and too simplistic to be useful in many customer service applications where flexibility is required.

The ASR industry is aware of the complexity of using Voice XML and SALT and a number of software tools have been created to make dialog development with ASR much easier. One of the better known tools is being sold by a company called Audium. This is a development environment that incorporates flow diagrams for dialogs, similar to the Microsoft product VISIO, with drag-and-drop graphical elements representing parts of the dialog. The Audium product represents a flow diagram style that most of the newer tools use.

Each graphical element in the flow diagram has a property sheet that the developer fills out. Although this tool improves the productivity of dialog developers by about a factor of about 3 over developing straight from Voice XML and SALT, there are a number of remaining issues with a totally graphical approach to dialog development:
Real world dialogs often have conditional flows and nested conditionals and loops. These occupy very large spaces in graphical tools making it confusing to follow.
A lot of the development work for real world dialogs is exception handling, which still have to be thoroughly programmed. Also, these additional conditionals add graphical confusion for the developer to follow.
In general, flow diagrams are useful for simple flows with few conditionals. Real world ASR dialogs, especially long ones, have many conditionals, confirmation loops, exception handling and multi-nested dialog loops that are still difficult to develop using flow diagrams. More importantly, most of the low level process and structure that is manually programmed with VoiceXML and SALT still need to be explicitly entered into the flow diagram.

The commercialization of speech dialog technology has requirements that can include handling hundreds or thousands of simultaneous conversations. However, commercialization is inhibited by the relative processing slowness of the known approaches.

### SUMMARY OF THE INVENTION

There are three aspects in relation to the present invention that enhance the speed of operation. A first aspect takes advantage of the relative speed improvement that compiled code offers over interpreted code. A second aspect minimizes the overhead and expense associated with maintaining state information for dialogs due to storage and reload of such state information. A third aspect provides for using standard technology elements to achieve the first and second aspects.

The present invention provides an optimal combination of speed of development with flexibility of flow control and interfaces for commercial speech dialogs and applications. Dialogs are viewed as procedural processes that are mostly easily managed by procedural programming languages. The best examples of managing procedural processes having a high level of conditional flow control are standard programming languages like C++, Basic, Java and JavaScript

A dialog is represented as not just a sequence of forms, but may also include flow control, context management, call management, dynamic speech grammar generation, communication with service agents, data transaction management (e.g., database and web services) and fulfillment management which are either very difficult or not possible to program into current, standard voice interfaces such as Voice XML and SALT scripts. These functions may be integrated into scripts.

One embodiment of the invention adapts features of standard procedural languages, dynamic web services and standard integrated development environments (IDEs), toward developing and running automated speech response dialogs.

A high level programming language is used to develop scripts which share knowledge between a person and a virtual agent for the purpose of solving a problem or completing a transaction. The scripts are compiled into application libraries. The resulting application libraries may be used, for example, as dynamically linked libraries activated during the run time of the speech processing system.

Each dynamically linked library may be responsible for a particular type of dialog with users. In one embodiment of the invention, a script manager is responsible for matching communications from the users with appropriate dynamically linked libraries. When a first communication is received from a user, the script manager may identify the correct application library to handle the communication and initialize a process of execution of the correct application library. That process of execution of the dynamically linked library may then remain in execution (that is, running on a processor) throughout the conversation with the user.

In a preferred embodiment of the invention, a process of execution of a dynamically linked library is responsible for maintaining state and data relevant to the conversation with the user from one communication to the next. A process of execution of a dynamically linked library may be capable of directing the dialog, generating suitable responses and updating the system state in response to the user requests. One process of execution of a dynamically linked library may call on other application libraries in order to further process communication data.

After processing a communication from the user, the process of execution of the dynamically linked library puts itself into a dormant state pending the next communication so as not to take up processing resources. When the next communication is received, the script manager identifies the proper process of execution of the appropriate dynamically linked library and activates that process of execution to handle the communication.

Numerous instances of communication formats, for example, web pages, may be used for communication to and from the user, while the same process of execution of the dynamically linked library handles all of them at the processing end. In order to keep track of the conversations and corresponding processes of execution of dynamically linked libraries, the script manager may use a system of tokens. A unique token may be generated in response to the first communication from the user and embedded in a reply. The same token is then returned with the following communications from the user. The script manager may maintain a table of mappings between the unique tokens and associated processes of execution of the application libraries. When a communication from a user is received, the script manager extracts the embedded token and selects an appropriate process of execution of a dynamically linked library based on the extracted token.

This system of using processes of execution of application libraries to maintain state data in between communications with a user is not limited to speech processing systems and may be employed in connection with any network server processing communications from users in a multiplicity of on-going conversations or sessions.

The run time process of execution of a dynamically linked library responds to a user through either a voice gateway using speech or through an Internet browser using HTML text exchanges, both of which are derived from the DLLs, internal and external data sources and associated properties. In some embodiments of the present invention, the text dialog mode may be used to simulate a speech dialog for debugging the flow of scripts. However, in other embodiments, the text dialog may be the basis for a virtual chat solution in the market.

Based on the result of the processing of communication from the user, the communications interface preferably delivers a message to the user such as a person. The data interface may deliver a message to a non-person user as well. The message may be a response to a user query or may initiate a response from a user. The communications interface may be a network server, such as, for example, a voice gateway, Web server, electronic mail server, instant messaging server (IMS), multimedia messaging server (MMS), or virtual chat system.

In one embodiment of the invention, the application and voice gateway preferably exchange information using either the VoiceXML or SALT interface language. Furthermore, the result is typically in the form of VoiceXML scripts within an ASP file where the VoiceXML references are either or both speech grammar and audio files. Thus, the voice gateway message may be in the form of playing audio for the user derived from the speech grammar and audio files. The message, however, may be in various forms including text, HTML text, audio, an electronic mail message, an instant message, a multimedia message, or graphical image.

The user input may also be the form of text, HTML text, speech, an electronic mail message, an instant message, a multimedia message, or graphical image. When the user input is in the form of speech from a caller user, the user speech is typically converted by the communications interface into user input text using any standard speech recognition technique, and then delivered to the appropriate application.

The dialog information kept by a process of execution of a DLL may include dialog prompts, audio files, speech grammars, external interface references, one or more scripts, and script variables. The application may perform interpretation on a statement by statement basis where each statement resides within the project file.

Standard or proprietary script or software programming languages may be used for development of DLLs. In a preferred embodiment of the invention, the language for application library development is C#. In alternative embodiments, other languages may be used, such, as for example, C++, C, JAVA, JavaScript, JScript, VBScript, VB.Net, Pearl, PHP, and other standard or proprietary languages known to one skilled in the art.

### BRIEF DESCRIPTION OF THE DRAWINGS

FIG. 1 shows a speech dialog processing system in accordance with the principles of the present invention.

FIG. 2 shows a process flow according to principles of the present invention.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

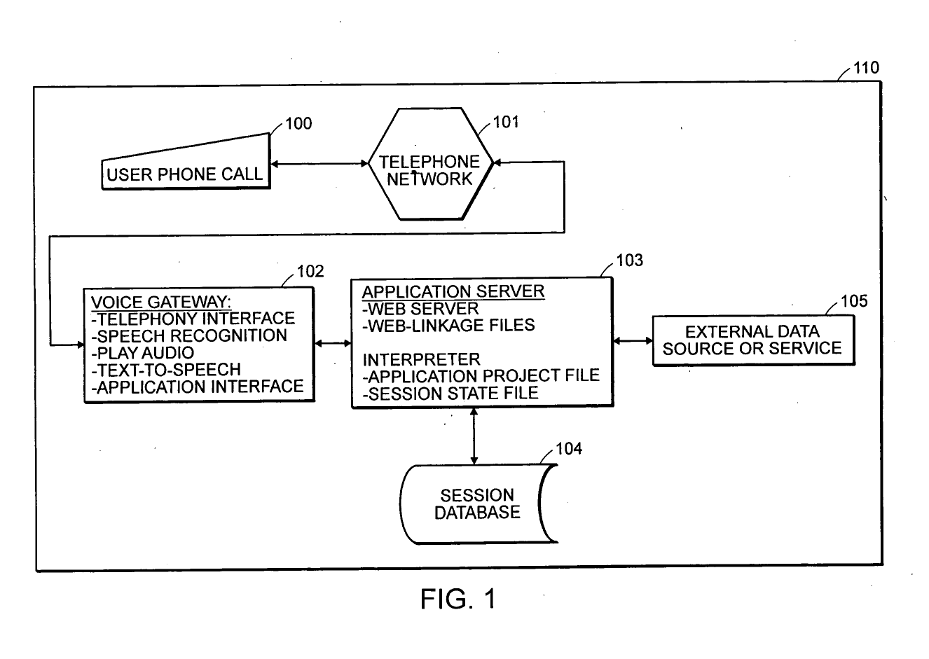

The present approach provides a method and system for developing and running automated speech recognition dialogs. FIG. 1 illustrates one embodiment of a speech dialog processing system 110 that includes communications interface 102, i.e., a voice gateway, and application server 103. A telephone network 101 connects telephone user 100 to the voice gateway 102. In certain embodiments of the invention, communications interface 102 provides capabilities that include telephony interfaces, speech recognition, audio playback, text-to-speech processing, and application interfaces. The application server 103 may also interface with external data sources or services 105.

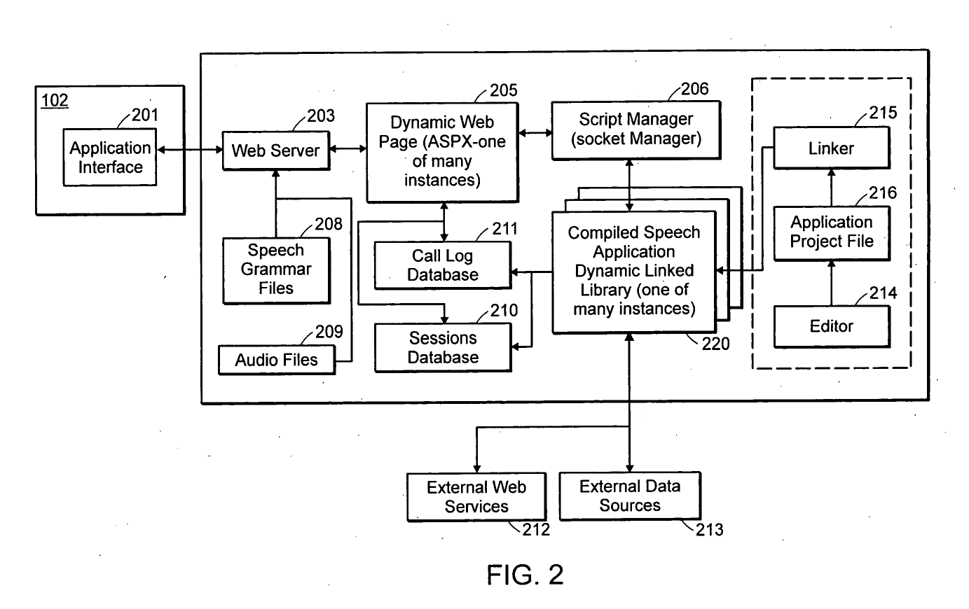

As shown in FIG. 2, application server 103 includes a web server 203, speech grammar files 208, audio files 209, call log database 211, sessions database 210, script manager 206, and compiled speech application dynamically linked libraries 220. Application server 103 processes communications from users and sends back appropriate responses. Processing of a communication from a user begins when a message is accepted from an application interface 201 at web server 203, after which speech grammar files 208 and audio files 209 are used to interpret the message. Data from the received communication is ultimately processed by an application designed to control the flow of conversation on a particular topic or with a particular set of goals. In one embodiment of the invention, such specialized application may be a dynamically linked library. There may be numerous dynamically linked libraries, each geared toward a particular type of conversations. For example, there may be dynamically linked libraries (DLLs) for processing change of password conversations, balance request conversations, or any other conversation provided as part of the speech communication system.

Script manager 206 is chiefly responsible for taking data from communications 205 and passing it to the appropriate compiled dynamically linked library 220 for processing. Dynamically linked libraries may use information from external web services 212 and external data sources 213 during execution.

The dynamically linked libraries are designed to run dialogs which share knowledge between a person and a virtual agent for the purpose of solving a problem or completing a transaction.

Dynamically linked libraries 220 may be originally created using editor 214 from any standard or proprietary computer language, such as, for example, C#, JAVA, JavaScript, JScript, C++, Visual Basic, VB. NET, etc. After the libraries are written, they are compiled into application project files 216, which are then linked with the speech processing system using linker 215. The steps of writing and compiling dynamically linked libraries generally happen offline, before the execution of the speech processing system. In an alternative embodiment of the invention, additional dynamically linked libraries may be added during the execution of the speech processing system, as deemed necessary by one of skill in the art.

The use of compiled libraries, instead of interpreted scripts, greatly speeds up the processing of information. Furthermore, information used and obtained during a particular conversation may be kept by a process of execution of a dynamically linked library in charge of the conversation.

The process of execution is initialized in order to process the first communication in a conversation and continues running for the duration of that conversation. In such a way, the application server need not write state information to a database or to specific memory structures, instead, control over keeping conversation state and related data is passed to the instances of execution of dynamically linked libraries. For example, if a caller calls to change a password, script manager 206 will identify the proper dynamically linked library—e.g. the password change library—and initiate it, passing to it data from the initial communication from the user. The initiated instance of the dynamically linked library processes the communication and responds with an appropriate response back to script manager 206, which forms a dynamic web page 205 based on DLL's response. The resulting dynamic web page is then returned to the user through web server 203. When a communication from the same user next comes in, script manager 206 passes it to the same process of execution of the password change compiled dynamically linked library.

In between processing the communications from the user, the process of execution of the compiled dynamically linked library puts itself into a dormant mode, awaiting the next communication. When the communication comes in, the script manager 206 locates the appropriate dynamically linked library and wakes it up from its dormant state.

A dynamically linked library controls the conversation with the user, directing the flow of conversation and controlling execution of auxiliary applications and libraries. By putting itself into a dormant state in between communications, it does not draw up additional processing resources, yet, by remaining in execution throughout the conversation, it significantly cuts down the response time by processing the data as it comes in and keeping the state of the conversation in memory, instead of having to rely on a database or interpreted scripts. The compiled nature of the library allows for faster execution on modern processors.

It should be noted that a process of execution of a dynamically linked library is not the same as the compiled dynamically linked library itself. As will be apparent to one skilled in the art, there may be multiple processes of execution of one compiled dynamically linked library at the same time. For example, several users may be in the middle of multiple conversations with similar goals with the speech interpretation system, using the same application dynamically linked library—for example, each changing their own passwords—while the multiple processes of execution of the DLL supporting the conversation will be functionally separate and distinct from each other and will not share data or details about flow control of the conversations. In essence, there will be as many processes of execution of the application dynamically linked library as there are ongoing conversations.

As will be apparent to one of skill in the art, there can be any number of application dynamically linked libraries present in the system, from one to hundreds and even thousands, without additionally taxing the system if their execution is not needed at the moment. The application libraries may be narrowly tailored to particular conversations or they may be fairly general, capable of directing the conversation to other application dynamically linked libraries.

Because there may be any number of processes of execution of dynamically linked libraries at the same time, script manager 206 needs to be able to direct a particular communication to the appropriate process of execution of a compiled library. In order to do so, it keeps a mapping between active conversations and processes of execution of DLLs supporting them.

In one embodiment of the invention, the mapping between the conversations and the processes of execution of the DLLs is supported with the help of tokens embedded in communications to and from users. A unique token may be generated by script manager 206 when responding to an initial communication from a user and is embedded in a reply, for example, in a dynamic web page 205, which is then transmitted to the user. In responding to the initial reply, the application interface 201 takes the embedded token and, in turn, embeds it into a second communication from the user, so that when it arrives at the script manager 206, the script manager 206 is able to associate it with the correct conversation based on the token. In one embodiment of the invention, script manager 206 maintains a mapping of unique tokens to the processes of execution of dynamically linked libraries, thus keeping track of the conversations with which these tokens are associated. This mapping may be maintained, for example, in a table, a tree or any other data structure, as deemed appropriate by one of skill in the art. In an alternative embodiment of the invention, conversations may be maintained using tools other than tokens.

When a communication is received by the web server, script manager 206 extracts a token embedded in it and selects an appropriate process of execution of an application library based on the token such as, for example, by looking it up in the table of mappings between the tokens and processes of execution of DLLs. After selecting the proper process of execution of a DLL, script manager 206 activates the process of execution of the DLL from its dormant state.

Script manager 206 need not be aware of the particular details of the conversations happening between users and various processes of execution of dynamically linked libraries. The main task of the script manager 206 is to associate a conversation with a dynamically linked library and then, upon additional communications from the user in this conversation, to pass the communications to the appropriate process of execution of that dynamically linked library, by waking it up from its dormant state.

Any scripting or software programming languages may be used to define dialogue dynamically linked libraries. For example, such languages may include C#, C++, C, JAVA, JavaScript, JScript, VBScript, VB.Net, Pearl, PHP, and other standard or proprietary languages known to those skilled in the art. In an alternative embodiment of the invention, such languages may also be enhanced with specific functions focused on speech dialogs. Scripts generated from these scripting and software programming languages are compiled directly into executable code avoiding the need for an interpreter. For example, a set of dialog scripts may be defined using the C# programming language and compiled directly into executable code, resulting in application libraries.

The use of dynamically linked compiled libraries has been described herein in connection with the speech processing system. However, as will be apparent to one of skill in the art, such application of compiled application libraries is not limited to speech processing and may be employed in connection with practically any network server processing. The key advantage of using the compiled dynamically linked libraries is that they live throughout an entire conversation (session) with a user and contain all the application context, while there may be many instances of dynamic web pages and many unique tokens which are passed back and forth between the application interface and the processing system. The script manager 206 brokers data transferred between multiple instances of dynamic web pages and instances of execution of dynamically linked libraries. This system allows for flexible and fast processing of information at a communication server.

Referring again to FIG. 1, an overview of the interactions of the processes involved with the dialog session processing system 110 is described as follows:
The user 100 places a call to a dialog session speech application through a telephone network 101.
The call comes into a communications interface 102, i.e., the voice gateway. The voice gateway 102, which may be implemented using commercial voice gateway systems available from such vendors as VoiceGenie, Vocalocity, Genisys and others, has several internal processes that include:
   Interfacing the phone call into data used internal to the voice gateway 102. Typical input protocols consists of incoming TDM encoded or SIP encoded signals coming from the call.
   Speech recognition of the audio that the caller speaks into text strings to be processed by the application.
   Audio playback of files to the caller.
   Text-to-speech of text strings to the caller
   Voice gateway interface to an application server in either Voice XML or SALT
   The voice gateway 102 interfaces with application server 103 containing web server 203, application web-linkage files, Script Manager 206 and dynamically linked libraries application 220. The interface processing between the voice gateway 102 and application server 103 loops for every turn of conversation throughout the entire dialog session speech application.

FIG. 2 shows the steps taken by script manager 206 in more detail: The Application Interface 201 within communications interface 102 interfaces to Web server 203 within Application Server 202. The Web Server 203 first serves back to the communications interface 102 initialization steps for the dialog session application from the Initial Speech Interface File 204. Thereafter, Application Interface 201 calls Web Server 203 to begin the dialog session application loop through script manager 206 which activates appropriate process of execution of a dynamically linked library 220.

On a given turn of conversation, the appropriate process of execution of a dynamically linked library gets the text of what the user says (or types) from Application Interface 201. When the process of execution of the DLL and script manager 206 complete the processing for one turn of conversation, script manager 206 delivers that result back to Application Interface 201 through ASP file 205 and Web Server 203. The result is typically in a standard interface language such as VoiceXML or SALT. In the result, there may be references to Speech Grammar Files 208 and Audio Files 209 which are then fetched through Web Server 203. At this point, the voice gateway 102 plays audio for the user caller to hear the computer response message from a combination of audio files and text-to-speech and then the voice gateway 102 is prepared to recognize what the user will say next.

The process of execution of the DLL maintains the updated state data and puts itself into the dormant state after each turn of conversation.

Within any turn of conversation there may also be calls to external Web Services 212 and/or external data sources 213 to personalize the conversation or fulfill the transaction. When the user speaks again, the process of execution of the DLL 220 is activated again to process the next turn of conversation.

It will be apparent to those of ordinary skill in the art that methods involved in the present invention may be embodied in a computer program product that includes a computer readable and usable medium. For example, such a computer usable medium may consist of a read only memory device, such as a CD ROM disk or conventional ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computer-implemented method of using compiled libraries for data processing on a network server, said method comprising:
receiving, at the network server, a first communication from a client;
associating a process of execution of a compiled library with a conversation with the client;
associating a unique token with the conversation with the client and embedding it in a response to the first communication;
the process of execution of the complied library remaining dormant waiting for a second communication from the client; and
processing the second communication from the client by reactivating the same process of execution of the compiled library.

2. The method of claim 1, further comprising:
maintaining, by the process of execution of the compiled library, data relevant to the conversation with the client.

3. The method of claim 1, further comprising:
receiving, at the network server, a first communication from a second client;
associating a unique token with a conversation with the second client; and
maintaining, in a data structure, mapping between unique tokens and processes of execution of compiled libraries.

4. The method of claim 3, further comprising:
upon receipt of the second communication from the client, using the unique token embedded in the second communication to select the process of execution of the compiled library to process the data from the second communication.

5. The method of claim 1, wherein the data processing on the network server is part of a speech conversation management system, each conversation capable of supporting one or more turns of conversation between the client and virtual agent, and wherein the process of execution of the compiled library determines recognition, response, and flow control in a conversation with the client.

6. The method of claim 1, wherein the compiled library is a compiled library of a script written in at least one of the following programming languages: C#, C++, C, VB.NET, VB, Java, Jscript and Java Script.

7. A computer-implemented data processing system comprising:
a network server receiving communications from clients;
a plurality of processing instances of compiled libraries, each processing communications from one client in a conversation and remaining dormant waiting for the next communication in the conversation; and
a script manager maintaining a mapping between conversations with the clients and the plurality of processing instances of compiled libraries using a set of unique tokens.

8. The computer-implemented data processing system of claim 7, wherein each processing instance of a compiled library maintains state of the conversation with the client in between communications from the client.

9. A computer-readable medium comprising instructions for using compiled libraries for data processing on a network server, said instructions comprising:
instructions for receiving, at the network server, a first communication from a client;
instructions for associating a process of execution of a compiled library with a conversation with the client;
instructions for associating a unique token with the conversation with the client and embedding it in a response to the first communication;
instructions for putting the process of execution of the compiled library into a dormant state waiting for a second communication from the client; and
instructions for processing the second communication from the client by reactivating the same process of execution of the compiled library.

10. A computer-implemented method for processing communications from a user in a speech conversation management system, each conversation capable of supporting one or more turns of conversation between the user and a virtual agent, said method comprising:
receiving a first communication from the user;
executing an appropriate compiled library for handling the recognition, response and flow control in a conversation with the user;
a process of execution of the appropriate compiled library remaining dormant waiting for a second communication from the user; and
processing the second communication from the user using the same process of execution of the appropriate compiled library.

11. The method of claim 10, further comprising:
associating a unique token with the process of execution of the compiled library;
embedding the unique token in a response to the first communication from the user;
receiving a second communication from the user, the second communication including the unique token; and
passing data from the second communication to the same process of execution of the compiled library.

12. The method of claim 11, further comprising:
maintaining, by the process of execution of the compiled library, data relevant to the conversation with the client.

13. The method of claim 11, further comprising:
maintaining, in a data structure, mapping between unique tokens and processes of execution of compiled libraries.

14. The method of claim 11, further comprising:
selecting, based on the unique token, the same process of execution of the compiled library handling the recognition, response and flow control in the conversation with the user;

15. The method of claim 10, wherein the compiled library is a compiled library of a script written in at least one of the following programming languages: C#, C++, C, VB.NET, VB, Java, Jscript and Java Script.

16. A speech conversation management system, each conversation capable of supporting one or more turns of conversation between the user and a virtual agent, said system comprising:
a network server receiving communications from clients;
a plurality of processing instances of compiled libraries, each processing handling the recognition, response and flow control in a conversation with the user and remaining dormant waiting for the next communication in the conversation; and
a script manager maintaining a mapping between conversations with the clients and the plurality of processing instances of compiled libraries using a set of unique tokens.

17. The system of claim 16, wherein each processing instance of a compiled library maintains state of the conversation with the client in between communications from the client.

18. A computer-readable medium comprising instructions for processing communications from a user in a speech conversation management system, each conversation capable of supporting one or more turns of conversation between the user and a virtual agent, said instructions comprising:
instructions for receiving a first communication from the user;
instructions for executing an appropriate compiled library for handling the recognition, response and flow control in a conversation with the user;
instructions for a process of execution of the appropriate compiled library remaining dormant waiting for a second communication from the user; and
instructions for processing data from the second communication from the user using the same process of execution of the appropriate compiled library.

19. The computer-readable medium of claim 18, further comprising:
instructions for associating a unique token with the process of execution of the compiled library;
instructions for embedding the unique token in a response to the first communication from the user;
instructions for receiving a second communication from the user, the second communication including the unique token; and
instructions for passing data from the second communication to the same process of execution of the compiled library.
